(19) United States
(12) Patent Application Publication
(10) Pub. No.: US 2006/0206699 A1
(43) Pub. Date: Sep. 14, 2006

(54) Network boot system

(76) Inventors: Daisuke Yokota, Yokohama-shi (JP); Shinji Kimura, Sagamihara-shi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/124,233

(22) Filed: May 9, 2005

(30) Foreign Application Priority Data
Mar. 10, 2005 (JP) 2005-067553

(51) Int. Cl. G06F 15/177

(52) U.S. Cl. 713/1

(57) ABSTRACT

A computer transmits a boot request to a gateway server, and the gateway server, upon receipt of the boot request from the computer, receives boot data stored in a storage server using an upper protocol for security-enhanced communications, and transmits the boot data to the computer using a lower protocol for speed-oriented communications. Upon receipt of the boot data from the gateway server, the computer boots up using the received boot data.

### CROSS-REFERENCE TO RELATED APPLICATIONS

This application claims the foreign priority benefit under Title 35, United States Code, § 119 (a)-(d), of Japanese Patent Application No. 2005-67553, filed on Mar. 10, 2005 in the Japan Patent Office, the disclosure of which is herein incorporated by reference in its entirety.

### BACKGROUND OF THE INVENTION

This invention relates to a network boot system.

A boot is a series of processes carried out first in a computer when the computer is switched on, to place a variety of software such as applications and utilities into an operable condition, and mainly consists of a startup sequence for an operating system (OS). A master boot record (MBR) allocated at the first sector of a storage device equipped in the computer provides a pointer indicating the location (storage area) in which the OS is stored, so that the computer locates the OS using the pointer and loads it from the storage area into memory. In general, the location of the OS indicated by the MBR is in the storage area of the storage device (local disk) equipped in the computer to be booted up.

On the other hand, the progress of network technology has enabled another implementation scheme in which an OS is loaded via a network from a computer other than the computer to be booted up, using a network boot program (NBP) or the like, as described in JP 2000-259583 A, the disclosure of which is herein incorporated by reference in its entirety. The boot implemented according to this scheme will be hereinafter referred to as a network boot. The applicant of the present application previously proposed a data storage/readout control for a mass storage server for enabling a computer to perform a network boot; for details, see JP 2004-287477 A, the disclosure of which is herein incorporated by reference in its entirety. This serves to bring the readout speed under control, which would otherwise decrease upon concurrent or congested access from many clients.

The network boot involves communication or transmission of OS data between the computer to be booted up and the computer storing the OS data. Communications protocols used for such OS data transmission may include, for example, the Internet Small Computer Systems Interface (iSCSI), as described in the Internet Engineering Task Force (IETF), “iSCSI” retrieved on Feb. 13, 2004 through the Internet at http://www.ietf.org/internet-drafts/draft-ietf-ips-iscsi-20.txt.

The conventional network boot schemes as described above would disadvantageously place a heavy load on the computer to be booted up. To be more specific, for example, a central processing unit or CPU of the computer to be booted up may run an NBP to transport the OS data from the storage server of another computer on the network over TCP/IP (Transmission Control Protocol/Internet Protocol), such as the Internet, using the iSCSI protocol, and load the transported OS data into the main memory for processing. Consequently, the network boot has been successfully completed and the OS is up and running, so that a specific operating environment is established. It is thus understood that the NBP executes the majority of the processing, in this type of the conventional network boot scheme, which causes the computer to run at a lower execution speed, and software vendors to bear a higher development cost.

The processing on the iSCSI protocol and TCP/IP includes security and reliability enhancing functionality, which reduces the execution speed of the NBP accordingly. Moreover, the NBP that is to be executed prior to the OS bootstrap needs to implement the TCP/IP and iSCSI, which can be processed by drivers on the OS, and thus causes the software vendors to bear a higher development cost.

It would be desirable to realize a new network boot scheme with a lower load placed on the computer to be booted up, and the present invention has been made with consideration given to the above-described disadvantages in the conventional methods.

Illustrative, non-limiting embodiments of the present invention overcome the above disadvantages and other disadvantages not described above. Also, the present invention is not required to overcome the disadvantages described above, and an illustrative, non-limiting embodiment of the present invention may not overcome any of the problems described above.

### SUMMARY OF THE INVENTION

In one aspect of the present invention, a computer transmits a boot request to a gateway server, and the gateway server, upon receipt of the boot request from the computer, receives boot data stored in a storage server using an upper protocol for security-enhanced communications, and transmits the boot data to the computer using a lower protocol for speed-oriented communications. Upon receipt of the boot data from the gateway server, the computer boots up using the received boot data.

The gateway server receives the boot data using the upper protocol and thus takes on the task of security and reliability enhancing functionality as a proxy for the computer to be booted up. Therefore, an inventive network boot scheme with a lower load placed on the computer to be booted up is realized.

### BRIEF DESCRIPTION OF THE DRAWINGS

The above aspect, further features and other advantages of the present invention will become more apparent by describing in detail illustrative, non-limiting embodiments thereof with reference to the accompanying drawings, in which:

FIG. 1A is a schematic diagram outlining a computer system according to one exemplified embodiment of the present invention;

FIG. 1B is a schematic diagram showing an example of IP site arrangement for a computer system according to one exemplified embodiment of the present invention;

FIG. 2 is a schematic diagram of a computer system according to one exemplified embodiment of the present invention illustrated for detailed discussion;

FIG. 3 is a schematic diagram illustrating a gateway server according to one exemplified embodiment of the present invention;

FIG. 4 shows an example of an input/output buffer management table;

FIG. 5 shows an example of a computer management table;

FIG. 6 shows an example of a cache table;

FIG. 7 shows an example of a packet format for use in communication according to lower protocol;

FIG. 8A is a schematic diagram for explaining a process of transmitting OS data according to one exemplified embodiment of the present invention;

FIG. 8B is a schematic diagram for explaining a process after transmitting OS data;

FIG. 9 is a flowchart of a network boot process executed in a computer system according to one exemplified embodiment of the present invention;

FIG. 10 is a flowchart of a process executed in a disk access handler according to one exemplified embodiment of the present invention;

FIG. 11 is a flowchart of a congestion control process executed in a computer system according to one exemplified embodiment of the present invention;

FIG. 12 is a flowchart of a process executed in a relay processing unit according to one exemplified embodiment of the present invention;

FIG. 13 is a schematic diagram for explaining a process of transmitting OS data illustrated for the purpose of comparison with embodiments of the present invention; and

FIG. 14 is a schematic diagram illustrating a computer system illustrated for the purpose of comparison with embodiments of the present invention.

### DETAILED DESCRIPTION OF THE EXEMPLARY EMBODIMENTS

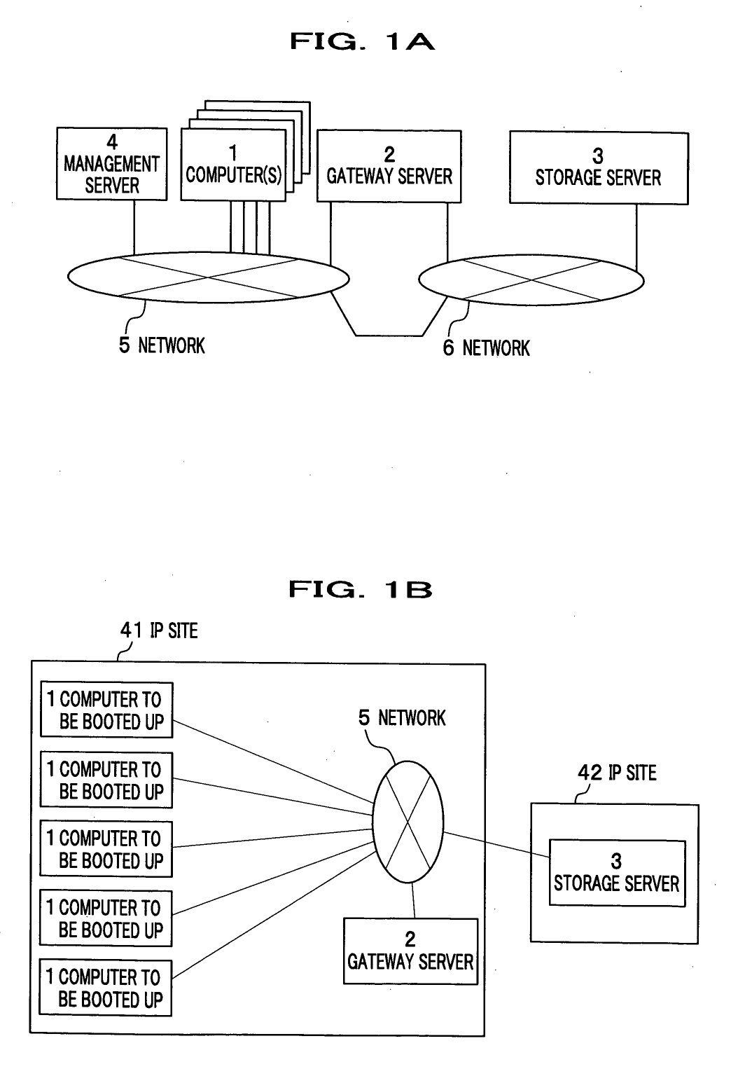

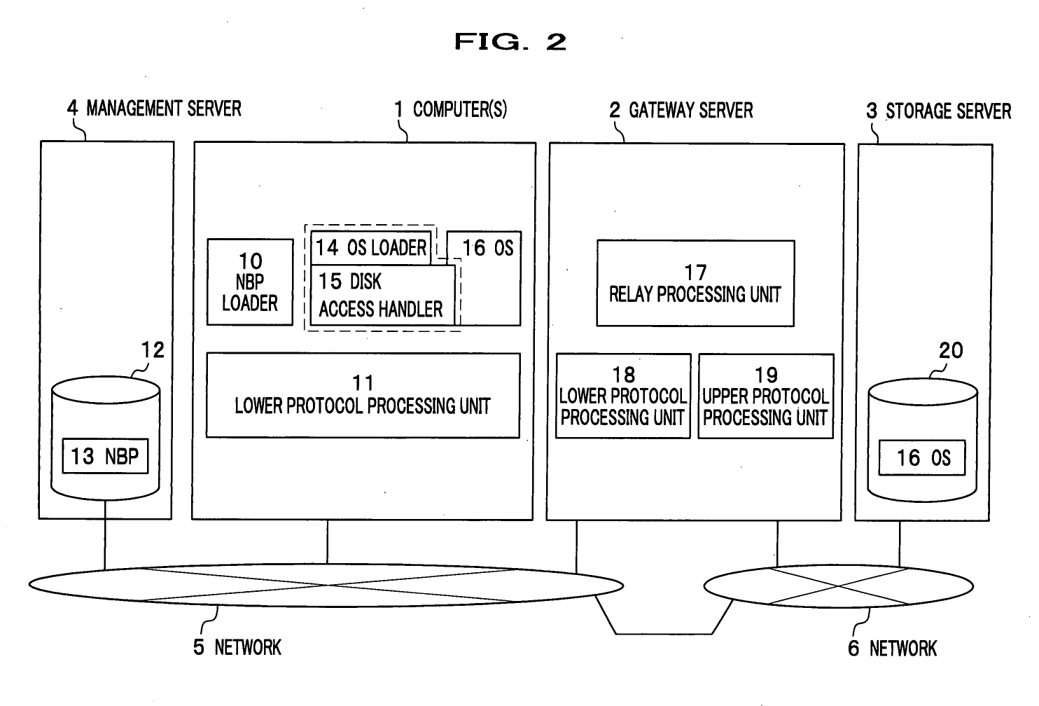

A computer system as exemplary embodiments of the present invention will be described in detail with reference to the drawings. Referring now to FIGS. 1A, 1B, 2 and 3, a general arrangement of a computer system according to one embodiment of the present invention comes up for discussion.

As shown in FIG. 1A, the computer system according to one embodiment of the present invention includes a management server 4, a computer (or computers) 1, a gateway server 2, and a storage server 3. A network 5 is provided to establish communications among the management server 4, the computer(s) 1, and the gateway server 2. A network 6 is provided to establish communications between the gateway server 2 and the storage server 3.

The components (management server 4, computer 1, gateway server 2 and storage server 3) making up the computer system may be provided each as a specifically configured computer, which includes but not limited to a processor (or arithmetic unit) and a memory (or main memory). The processor is typically composed of a central processing unit (CPU), and the memory is typically composed of a random access memory (RAM). The processor loads a program into memory and interprets instructions given by the program and executes arithmetic operations according to the instructions for a variety of functionality.

Since the storage server 3 contains boot data (e.g., OS data) for booting up the computer 1 having no boot data in its local disk, access to the storage server 3 via the network 6 (outside the secure network 5) using secure protocol such as iSCSI is enabled in the gateway server 2 so as for the computer 1 to receive via the gateway server 2 the boot data stored in the storage server 3. Assuming that the computer system is installed in a typical office environment, employees' starting times are likely to come within a short period of time in the morning, and many computers 1 are booted up in that short period of time. When multiple computers 1 are booted up substantially in unison, access of excessively many computers 1 to the storage server 3 would take place, leading to serious congestions. In view of the circumstances, according to the present embodiment, the gateway server 2 is provided for relaying and controlling the communications between the plurality of computers 1 and the storage server 3, so that congested access of multiple computers 1 are controlled appropriately.

As shown in FIG. 1B, a plurality of computers 1 to be booted up via network and a gateway server 2 are linked via a network 5 to form an IP site 41. The IP site 41 consists of a single IP segment (subnet), which may be made up of devices installed on one floor of the office, and thus forms a secure and reliability-enhanced network 5. In other words, communications between the computers 1 and the gateway server 2 are established via a local area network (LAN), which may for example be of a predetermined number of devices on a predetermined floor and constitute a single IP site 41; therefore, security and reliability thereof are ensured.

On the other hand, the storage server 3 is included in an IP site 42, different in IP segment from the IP site 41. The IP site 42 makes up the network 6 (shown in FIG. 1A), and the storage server 3 that is remote from the network 5 and for example located in a network center or computer room can establish communications with the network 5. The network 6 is neither secure nor reliable in comparison with the network 5.

Turning to FIG. 2, each component of the computer system according to one embodiment of the present invention will be described in detail.

The storage server 3 includes an OS storage unit 20 for storing an operating system or OS 16 that is to be used for network booting of the computer 1. The management server 4 includes an NBP storage unit 12 for storing a network boot program or NBP 13. The NBP 13 transfers OS data to the computer 1 from the storage server 3 that uses iSCSI protocol for communication, to start the OS 16, and thereby realizes network boot functionality of the computer 1. The management server 4 also serves as a DHCP (Dynamic Host Configuration Protocol) server and a TFTP (Trivial File Transfer Protocol) server (neither shown) according to one embodiment of the present invention.

To realize the network boot functionality, the computer 1 includes an NBP loader 10 for loading the NBP 13 into memory (of computer 1), an OS loader 14 for loading the OS 16, and a disk access handler 15 for handling a file system on a remote computer as if it were on a local disk. The NBP 13 according to the present embodiment does not have to provide functionality of enabling communications using TCP/IP or iSCSI protocol for enhancing security and reliability thereof. This allows each client computer 1 to be provided in a simplified construction at a low cost, without lowering the processing speed thereof.

The gateway server 2 includes a relay processing unit 17, a lower protocol processing unit 18, and an upper protocol processing unit 19. The relay processing unit 17 provides a data caching capability and a congestion control functionality to adequately respond to an upsurge or congestion of multiple boot requests. The lower protocol processing unit 18 serves to process data communication using a lower protocol to achieve high-speed communications, such as user datagram protocol or UDP. The upper protocol processing unit 19 serves to process data communications using an upper protocol to achieve security and reliability enhanced communications, such as TCP/IP and iSCSI protocol.

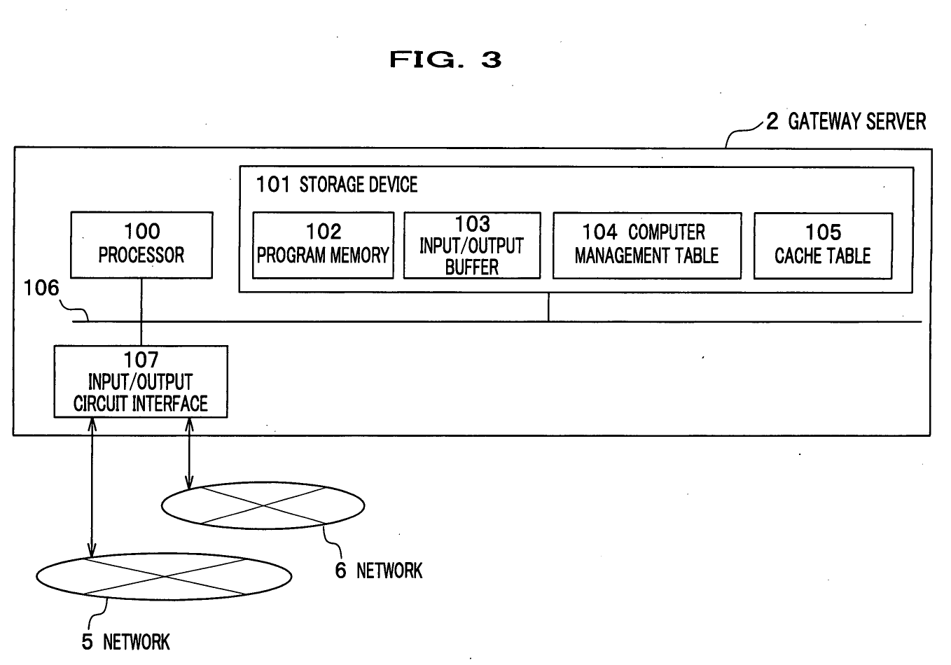

The gateway server 2 according to one embodiment of the present invention, as shown in FIG. 3, includes a processor 100, a storage server 101, an internal interface 106, and an input/output circuit interface 107. The storage server 101 includes a program memory 102 for storing a program, an input/output buffer 103 for buffering incoming and outgoing data packets, and storage space for storing a computer management table 104 and a cache table 105 associated with cached data.

The program memory 102 stores application programs for causing the gateway server 2 to execute a predetermined set of processes for implementing the functions of relay processing unit 17, lower protocol processing unit 18, upper protocol processing unit 19, etc.

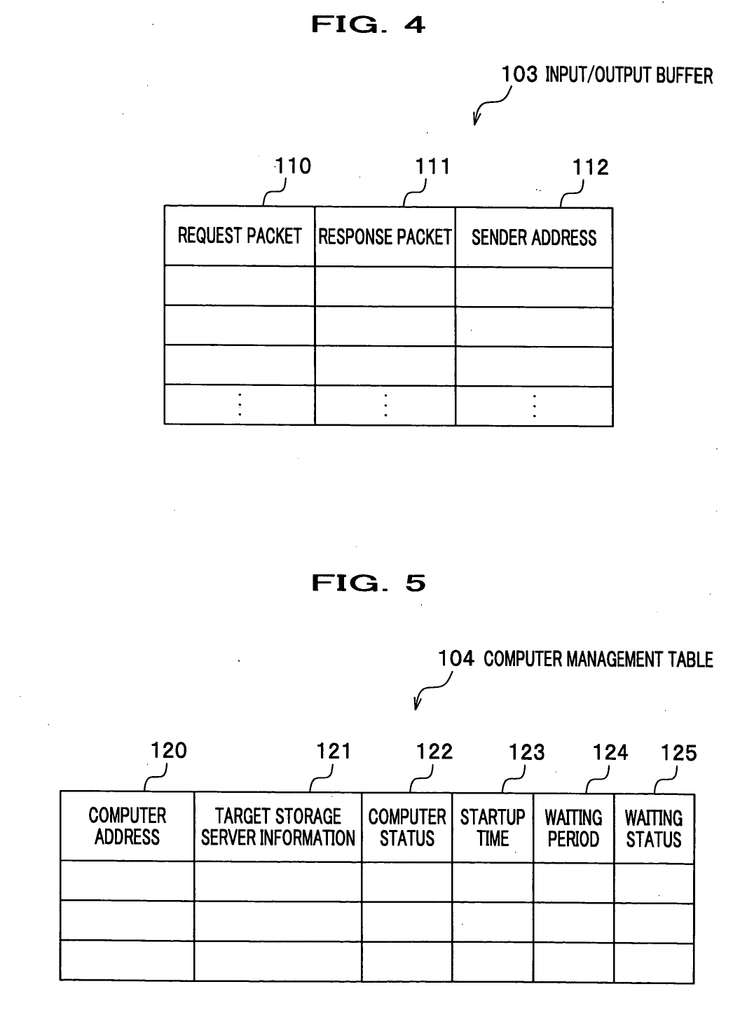

The input/output buffer 103 provides a memory area for buffering the data packets, and includes a receiving packet buffer 110 for temporarily storing request packets received and a transmitting packet buffer 111 for temporarily storing response packets to be transmitted, both of which are stored in a correlated manner and associated with a sender address 112 that is an IP address of each computer 1 originating the corresponding request packet, as shown in FIG. 4.

The computer management table 104, as shown in FIG. 5, contains a computer address 120 indicative of an IP address of each computer 1, target storage server information 121 indicative of an IP address and iSCSI target name (disk identifier) of storage server 3 which the computer 1 is to use, a computer status 122 indicative of the power status of the computer 1 (whether the computer 1 is powered on or off), a startup time 123 indicative of the time when the computer 1 is powered on, to be used for congestion control, a waiting period 124 indicative of the period of time for the next response packet 111 to wait before transmission, and a waiting status 125 that is a flag indicative of whether the response packet 111 falls within the waiting period or not, all of which are correlated for each packet and managed in an optimized manner.

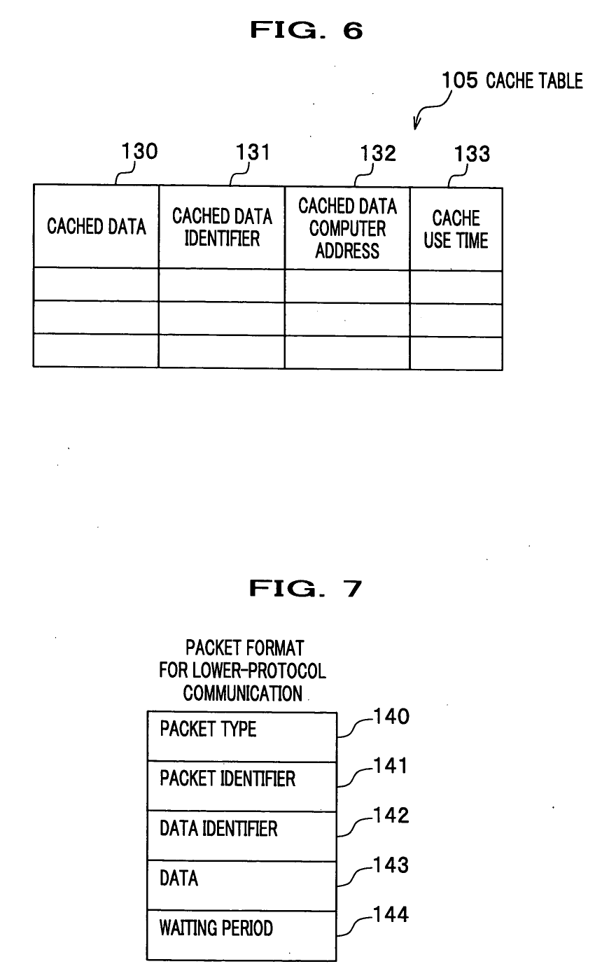

The cache table 105, as shown in FIG. 6, contains cached data 130 obtained from the storage server 3 (generally consisting of a 512 byte-sector of data), cached data identifier 131 indicative of a sector number or the like, a cached data computer address 132 indicative of an IP address of each computer 1 to which the cached data are to be forwarded, and a cache use time 133 indicative of the time when the cached data is forwarded to the computer 1, all of which are correlated for each packet of cached data and managed in an optimized manner.

Communications via the network 5 are established using the lower protocol, such as UDP, and the lower protocol processing units 11 and 18 of the computer 1 and the gateway server 2 respectively handles data packets having a specific format conforming to the predetermined lower protocol. Each packet the lower protocol processing unit 18 (and 11) processes, as shown in FIG. 7, contains, other than a UDP header, information on a packet type 140 indicative of whether the packet is a request packet or a response packet, a packet identifier 141 for identifying a response packet corresponding to a request packet, a data identifier 142 indicative of a sector number or the like, data 143 generally consisting of a 512 byte-sector of data, and a waiting period 144.

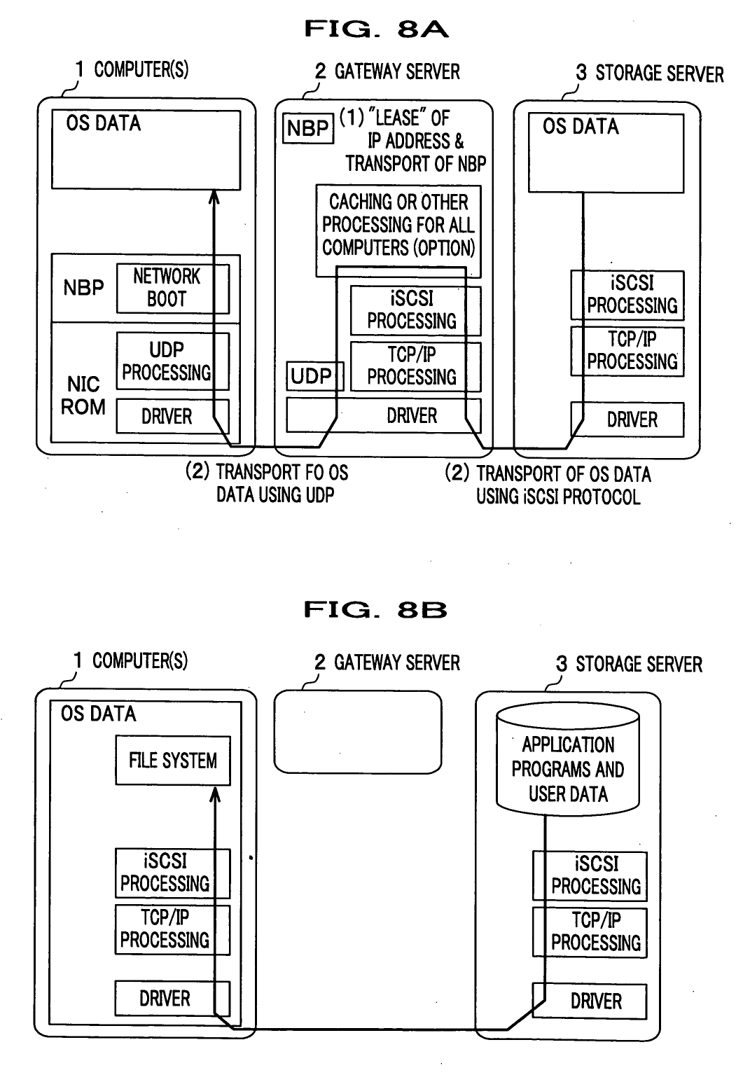

The general arrangement of the computer system according to one embodiment of the present invention has been described above. The next description will be directed to an operation of the computer system according to the present embodiment with reference made mainly to FIG. 8, and to FIGS. 1 through 7, as appropriate.

A process of transmitting OS data and a process after transmitting the OS data in the computer system according to one embodiment of the present invention are illustrated in FIGS. 8A and 8B, respectively.

As shown in FIG. 8A, what the gateway server 2 serving also as a DHCP server according to one embodiment of the present invention is configured to do first when the computer 1 is powered on is to assign (or “lease”) a unique IP address to the computer 1 so that the computer 1 can establish communications over UDP or TCP/IP (e.g., via a LAN) with the gateway server 2, and to transport a NBP to the computer 1. The DHCP service and NBP transport are both performed by the gateway server 2 using UDP. The UDP is a communications protocol provided in a network interface card read only memory (NICROM), and the communications between the computer 1 and the gateway server 2 in the course of the network boot process are established using UDP. The NBP loaded and executed in the computer 1 then transmits a boot request to the gateway server 2. In response thereto, the gateway server 2 accesses the storage server 3 using iSCSI protocol over TCP/IP to obtain OS data stored in the storage server 3. The storage server 3 establishes communications with a network 6 (of which security and reliability is relatively low) shared by the gateway server 2 using iSCSI protocol over TCP/IP. The OS data stored in the storage server 3 is transported to the gateway server 2 using iSCSI protocol, and further transported to the computer 1 using UDP.

As described above, the data transport from the storage server 3 outside the secure network using iSCSI protocol over TCP/IP, which was executed by the NBP in the conventional network boot scheme, is executed by the gateway server 2 that can utilize the functions of operating system and drivers. Consequently, the execution speed of the NBP can be improved, and the development cost of the whole system can be reduced.

As shown in FIG. 8B, the computer 1 that has finished receiving the OS data and thus has been successfully booted up has been freed from the limitations imposed during the network boot process by the NBP and its UDP-based communication, and can utilize the functions of operating system and drivers, with the result that a user of the computer 1 can enjoy the same access functionality as provided in the conventional scheme.

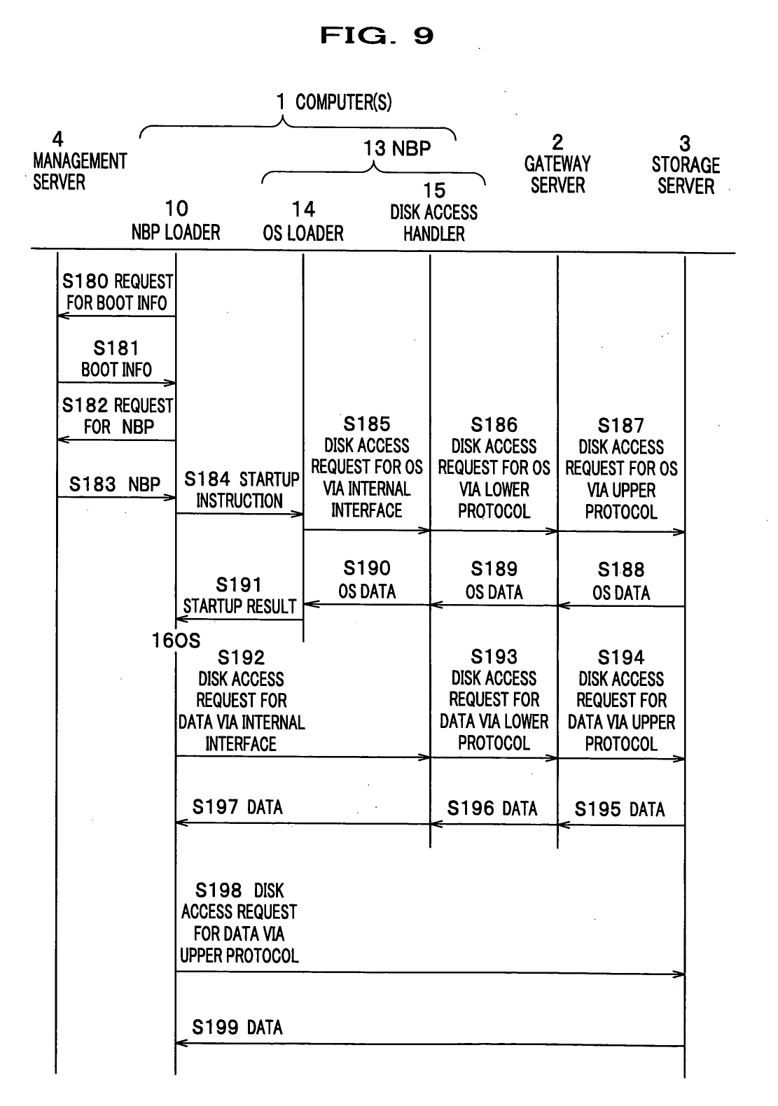

Referring now to FIG. 9, a description of the network boot process according to one embodiment of the present invention will be given further in detail. The process of transmitting OS data as shown in FIG. 8A corresponds to steps S180-S191 of FIG. 9, and the process after transmitting the OS data as shown in FIG. 8B corresponds to steps S198-S199.

First, the process of transmitting OS data (S180-S191) is described. The NBP loader 10 makes a request to the management server 4 for boot information of the computer 1 (S180). In cases where the management server 4 serves as a DHCP server and as a TFTP server storing the NBP 13, the boot information may include for example an IP address of the computer 1, an IP address of the management server 4 from which the NBP 13 is obtained, and a file name of the NBP 13.

Next, the management server 4 responds to the request and transmits the boot information of the computer 1 to the NBP loader 10 of the computer 1 (S181). The NBP loader 10 then makes a request to the management server 4 for the NBP 13 (S182). In response, the management server 4 allows the NBP 13 to be loaded into the computer 1 (S183).

The NBP loader 10 then gives the OS loader 14 instructions to start up (S184). To be more specific, the internal interface 106 through which the computer 1 accesses a disk is switched to the disk access handler 15. In actuality, it is realized by hooking the BIOS call. The OS loader 14 can load the OS 16 by following specified procedural steps. More specifically, to load the OS 16, data located at a specific position (at sector “0”) on a disk image for computer 1 in the storage server 3 is stored at a specific address in the computer 1, and executed.

The OS loader 14 that has thus received the instructions makes a request through the internal interface 106 to the disk access handler 15 for disk access to obtain the OS (S185). Then, the disk access handler 15 makes a request using the lower protocol to the gateway server 2 for disk access to obtain the OS (S186). The gateway server 2 in turn makes a request using the upper protocol to the storage server 3 for disk access to obtain the OS (S187).

In response to the request for disk access to obtain the OS, the process goes to the steps of transmitting the data 143 (see FIG. 7) of the OS 16. The storage server 3 transmits the data 143 (OS 16) to the gateway server 2 (S188). The gateway server 2 then transmits the data 143 (OS 16) to the disk access handler 15 (S189). The disk access handler 15 in turn transmits the data 143 (OS 16) to the OS loader 14 (S190). The OS loader 14 then starts up the OS 16 based upon the data 143 transmitted from the disk access handler 15, and notifies the NBP loader 10 of the startup result (S191).

Next the operation of the disk access handler 15 accessing the storage server 3 (S192-S197) is described. This operation is carried out for example when the OS 16 having finished its startup process utilizes the internal interface 106.

The OS 16 makes a request through the internal interface 106 to the disk access handler 15 for disk access (S192). The disk access handler 15 then makes a request using the lower protocol to the gateway server 2 for disk access (S193). The gateway server 2 in turn makes a request using the upper protocol to the storage server 3 for disk access (S194).

A process of responding to the request for disk access is described hereinafter. The storage server 3 transmits the data 143 to the gateway server 2 (S195). The gateway server 2 then transmits the data 143 to the disk access handler 15 (S196). The disk access handler 15 in turn transmits the data 143 to the OS 16 (S197).

The process after transmitting the OS data (S198-S199) is described. The OS 16 makes a request using the upper protocol to the storage server 3 for disk access (S198). The storage server 3 then transmits the data 143 to the OS 16 (S199). Likewise, once the OS 16 has started up, the OS 16 may directly access the storage server 3 using the upper protocol.

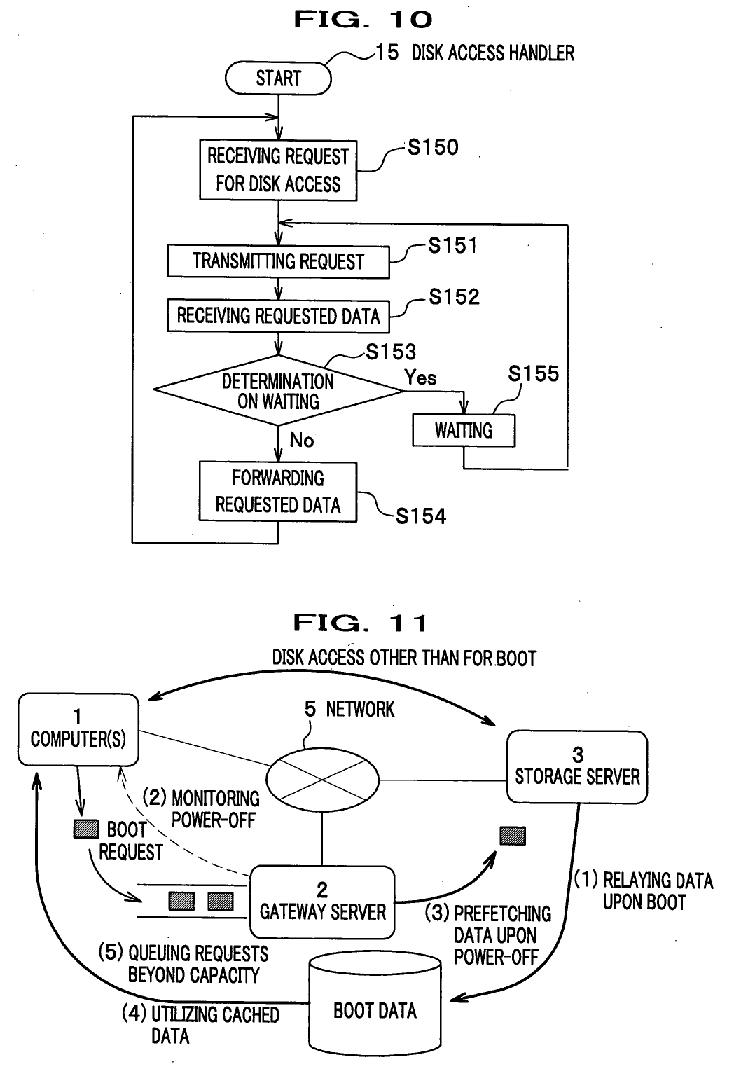

A description will be given of a process executed by the disk access handler 15 in the network boot process according to one embodiment of the present invention, with reference to FIG. 10. The disk access handler 15 of the computer 1 first receives a request for disk access to the storage server 3 from the OS loader 14 of the computer 1(S150). Next, the disk access handler 15 forwards the request to the gateway server 2 (S151). Then, the disk access handler 15 receives requested data obtained from the storage server 3 through the gateway server 2 (S152).

The disk access handler 15 makes a determination on waiting, i.e., determines whether the waiting period 144 of a packet is greater than “0”. If the packet is not placed in a queue of waiting (“No” at step S153), then the disk access handler 15 immediately responds to the request for disk access (S154), and the process returns to S150. On the other hand, if the packet is placed in a queue of waiting (“Yes” at step S153), then the disk access handler 15 waits for the waiting period 144 of the packet of data to be forwarded in response to the request, and the process goes back to S151.

A description will be given of a congestion control process of the network boot process executed in the computer system according to one exemplified embodiment of the present invention with reference to FIG. 11. This illustrated congestion control process, unlike general cache algorithms, uses the cache table 105, and thus can handle such an access pattern upon network boot of the computer 1 as the computer 1 loads the whole OS data once. To be more specific, the algorithm of the gateway server 2 according to one embodiment of the present invention having caching and congestion control capabilities to handle congested boot requests as shown in FIG. 11 carries out a “queuing” process, so as to achieve a stable operation even when the number of received requests runs out of capacity. The “queuing” is a process that puts packets of data to be transmitted in a queue, and proceeds to the next process before completion of the receiving process. The “queuing” process serves to prevent considerable loss in performance of the whole system due to the overrun or excessively congested requests. Accordingly, even upon congestion as a result of concurrent boot requests, congestion control is exerted so that the number of the boot requests to be processed may not go beyond the limits of performance of the gateway server 2 and the storage server 3.

The following are specific process steps of the algorithm shown in FIG. 11, to be carried out by the gateway server 2 for relaying the access to storage server 3 only upon boot.

Step 1: recording a sector number of data requested upon boot;

Step 2: detecting power off of computer 1;

Step 3: reading in advance the data from location indicated by the sector number recorded in step 1, so that the computer 1 can obviate the need for conforming whether cached data have been updated when establishing direct communications with the storage server 3 without intervention of the gateway server 2 after completion of the OS boot process;

Step 4: forwarding prefetched data in a cache if any corresponding to the request for access of the computer 1, to the storage server 3; and

Step 5: keeping track of the number of computers 1 booted up and the number of caching errors, for “queuing” the requests from the computers 1 in the gateway server 2 when the numbers of requests for network boot from the computers 1 go beyond the capacity of performance of the gateway server 2 and the storage server 3.

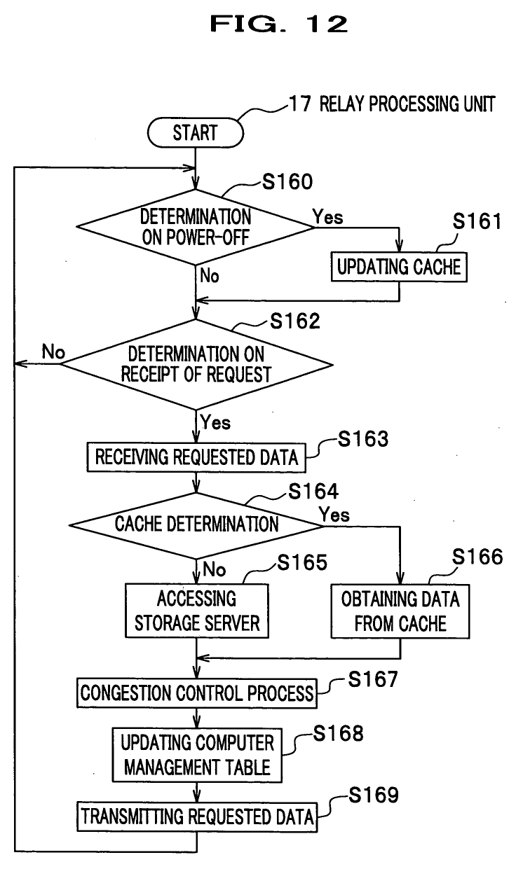

Referring now to FIG. 12, a process executed during the OS boot process in a relay processing unit according to one embodiment of the present invention will be described in detail. First, the relay processing unit 17 keeps track of the power supply state of all the computers 1 listed in the computer management table 104, and determines whether each computer 1 is powered off (S160). If the relay processing unit 17 determines that one or more of the computers 1 has been powered off (“Yes” at S160), then the relay processing unit 17 updates data in the cache (S161). To be more specific, all the rows in the cache table 105 with the computer address 120 corresponding to the computers 1 which have been powered off are updated by obtaining relevant data 143 from the storage server 3. Then, for each of these computers 1, the startup time 123 is cleared into “0” and the computer status 122 is changed into “power off”, in the computer management table 104.

Subsequently, the relay processing unit 17 determines whether a request for disk access has been received (S162). If no request has been received (“No” at S162), the process returns to S160. On the other hand, if the relay processing unit 17 determines that a request has been received (“Yes” at S162), then the relay processing unit 17 receives data requested (S163). Next, the relay processing unit 17 makes a cache determination (S164). The “cache determination” refers to a determination made as to whether a desired piece of data is stored in the cache.

If the cache determination at S164 turns out to be “Yes”, then the relay processing unit 17 obtains requested data by obtaining relevant data 143 from the cache table 105, and stores the obtained data in the input/output buffer 103 (S166). Hereupon, the cache use time 133 of the relevant data is updated by the present time. According to the above process, the data in a cache can be utilized as boot data without the need for checking the update of the boot data in the storage server 3.

On the other hand, if the cache determination at S164 turns out to be “No”, the relay processing unit 17 accesses the storage server 3 (S165). To be more specific, the relay processing unit 17 obtains the requested data from the storage server 3, and stores the obtained data in the input/output buffer 103 and in the cache with other pieces of information of the cache table 105. If the capacity of cache (memory) becomes short, the relay processing unit 17 discards one or more of the oldest data.

Next, the relay processing unit 17 carries out a congestion control process (S167) as illustrated in FIG. 11. To be more specific, if the response the storage server 3 is delayed and the response time is longer than a predetermined threshold, then data in the computer management table 104 is updated such that among data for the computers 1 with “0” in the waiting period 124 and “Off” in the waiting status 125, the data for a computer 1 with the newest time in the startup time 123 is updated to have a predetermined value set in the waiting period 124 with “On” in the waiting status 125.

Then, the relay processing unit 17 further updates the computer management table 104 (S168); namely, the relay processing unit 17 sets the present time if “0” is set in the startup time 123, “Power on” in the computer status 122, and “Off” in the waiting status 125. Next, the relay processing unit 17 transmits the obtained data to the computer 1 which has requested therefor (S169). If the waiting period 124 in the computer management table 104 is not “0”, the value of the waiting period 124 is set in the corresponding field in the data packet, i.e., the waiting period 144, “0” is set in the waiting time 124, and “On” is set in the waiting status 125.

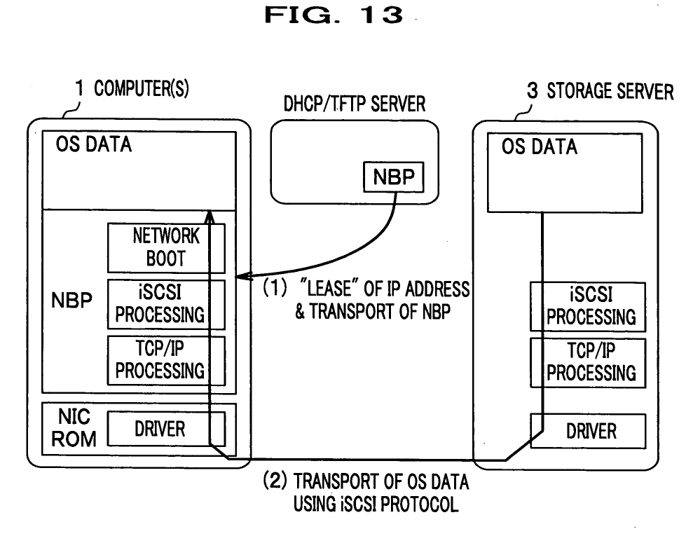

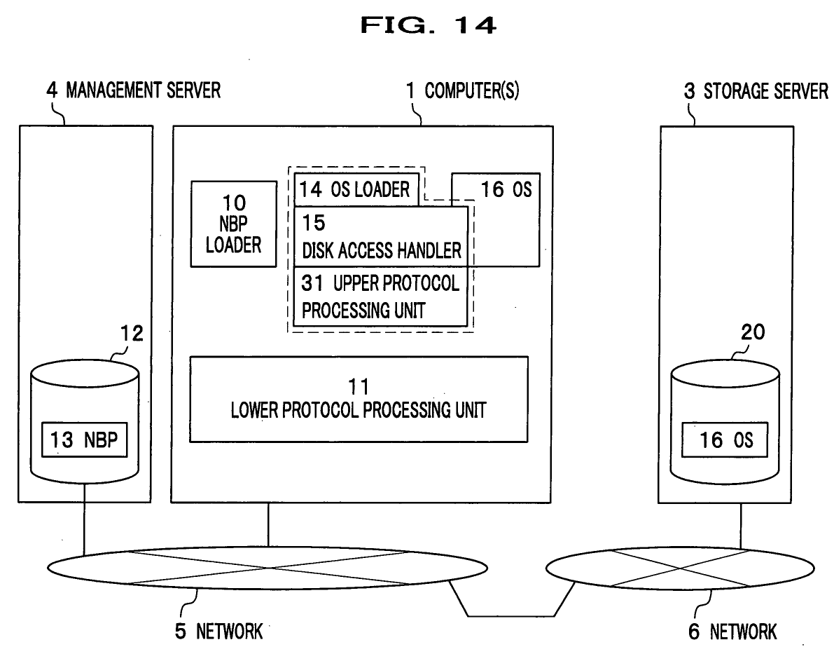

Operation of the computer system according to one embodiment of the present invention has been described above. Comparing with some examples, distinctive advantageous effects of embodiments of the present invention will be described with reference to FIGS. 13 and 14.

FIG. 13 is a schematic diagram for explaining a process of transmitting OS data illustrated for the purpose of comparison with embodiments of the present invention. Each computer 1 receives OS data directly from the storage server 3. Therefore, NBP 13 needs to have iSCSI and TCP/IP processing capabilities, and thus the computer 1 would necessarily have a complicated configuration. In contrast, the process of transmitting OS data according to one embodiment of the present invention as shown in FIG. 8A uses a gateway server 2 to carry out the iSCSI and TCP/IP processing as a proxy of each computer 1, and the computer 1 may be provided in a relatively simple configuration.

FIG. 14 is a schematic diagram illustrating a computer system illustrated for the purpose of comparison with embodiments of the present invention. Computer 1 has an upper protocol processing unit 31 for carrying out the iSCSI and TCP/IP processing, and the configuration of the computer 1 would necessarily become complicated. In contrast, the computer 1 according to one embodiment of the present invention as shown in FIG. 2 includes no upper protocol processing unit 3, and thus is simple in configuration.

It is contemplated that various modifications and changes may be made to the exemplary embodiments of the invention without departing from the spirit and scope of the embodiments of the present invention.

For example, the number of each component of the computer system is not limited to that illustrated in FIG. 1, for example.

Each component constituting the computer system may be embodied separately in one unit enclosed in a single housing, one unit having functions of multiple units may be embodied in a single housing. For example, a computer system including n units of computers 1 and one unit of gateway server 2 may be reconfigured into another computer system including (n−1) units of computers 1 and one unit of gateway serer 2 doubling as computer 1 in functionality. Accordingly, even when each of the components of the computer system has levels of performance different from one another, functions conforming to their respective level of performance can be assigned to the respective components.

Further, the gateway server 2 according to one embodiment of the present invention as described above is configured to have the both functions of iSCSI processing and TCP/IP processing; however, the gateway server 2 may be configured to have one of these functions.

The network boot methods consistent with the present invention as described above may be embodied in the form of a computer program (computer program product) which may be stored in a variety of computer readable media for distribution or execution, and arranged independently in a specifically designed computer system or associated with various types of existing computer systems which is part of a network environment or on which a network system is implemented.

What is claimed is:

1. A network boot method comprising:
allowing a computer to transmit a boot request to a gateway server;
allowing the gateway server to receive boot data stored in a storage server using an upper protocol for security-enhanced communications in response to the boot request received from the computer, and to transmit the boot data to the computer using a lower protocol for speed-oriented communications; and
allowing the computer to receive the boot data from the gateway server and to boot up using the boot data.

2. A network boot method according to claim 1, further comprising establishing communications between the computer and the gateway server via a local area network.

3. A network boot method according to claim 1, further comprising allowing the computer to receive a network boot program from the gateway server and to execute the received network boot program.

4. A network boot method according to claim 1, further comprising allowing the computer to receive a network boot program from a management server and to execute the received network boot program.

5. A network boot method according to claim 4, further comprising establishing communications between the computer and the management server via a local area network.

6. A network boot method according to claim 1, further comprising allowing the gateway server to queue a plurality of boot requests received from said computer and at least one of other computers, and to receive the boot data in a sequence conforming to the queuing of the plurality of the boot requests.

7. A network boot method according to claim 1, further comprising allowing the gateway server to temporarily store the received boot data in a cache before transmitting the boot data.

8. A network boot method according to claim 1, wherein the upper protocol includes iSCSI over TCP/IP.

9. A network boot method according to claim 1, wherein the lower protocol includes UDP.

10. A gateway server comprising:
an upper protocol processing unit to receive boot data stored in a storage server using an upper protocol for security-enhanced communications in response to a boot request received from a computer; and
a lower protocol processing unit to transmit the boot data to the computer using a lower protocol for speed-oriented communications.

11. A gateway server according to claim 10, wherein the upper protocol processing unit establishes communications via a local area network.

12. A gateway server according to claim 10, further comprising a network boot program to be received and executed by the computer.

13. A gateway server according to claim 10, further comprising a relay processing unit to queue a plurality of boot requests received from the computer and at least one of other computers by the lower protocol processing unit, wherein the upper protocol processing unit receives the boot data in a sequence conforming to the queuing of the plurality of the boot requests.

14. A gateway server according to claim 13, wherein the relay processing unit temporarily stores in a cache the boot data received from the storage server, and the lower protocol processing unit transmits the temporarily stored boot data to the computer.

15. A gateway server according to claim 10, wherein the upper protocol includes iSCSI over TCP/IP.

16. A gateway server according to claim 10, wherein the lower protocol includes UDP.

17. A computer system comprising:
a storage server to store operating system data;
a management server to store a network boot program;
a computer to be booted up using the operating system data stored in the storage server and the network boot program stored in the management server, wherein the computer includes an NBP loader for loading the network boot program and an OS loader for loading the operating system data;
a gateway server to receive the operating system data from the storage server and transmit the operating system data to the computer,
wherein the gateway server includes:
an upper protocol processing unit to receive operating system data stored in the storage server using an upper protocol for security-enhanced communications in response to a boot request received from the computer; and
a lower protocol processing unit to transmit the operating system data to the computer using a lower protocol for speed-oriented communications.

18. A computer system according to claim 17, wherein communications between the computer and the gateway server are established via a local area network.

19. A computer system according to claim 17, wherein communications between the computer and the management server are established via a local area network.

20. A computer system according to claim 17, wherein the gateway server further includes a relay processing unit to queue a plurality of boot requests received from the computer and at least one of other computers by the lower protocol processing unit, wherein the upper protocol processing unit receives the operating system data in a sequence conforming to the queuing of the plurality of the boot requests.

21. A computer system according to claim 17, wherein the relay processing unit temporarily stores the received operating system data in a cache, and the lower protocol processing unit transmits the temporarily stored operating system data to the computer.

22. A computer system according to claim 17, wherein the upper protocol includes iSCSI over TCP/IP, and the lower protocol includes UDP.

23. A computer executable program product stored on a computer readable medium, comprising the instruction steps of:
receiving a boot request from a computer to be booted up;
receiving boot data stored in a storage server using an upper protocol for security-enhanced communications in response to the boot request; and
transmitting the boot data to the computer using a lower protocol for speed-oriented communications.

24. A computer executable program product according to claim 23, further comprising the instruction step of transmitting a network boot program to the computer via a local area network.
